(19) United States
(12) Patent Application Publication
(10) Pub. No.: US 2026/0235173 A1
(43) Pub. Date: Aug. 13, 2026

(54) FRICTION BRAKING DEVICE

(71) Applicant: TALLANO TECHNOLOGIES, PARIS (FR)

(72) Inventors: Loïc ADAMCZAK, LOYETTES (FR); Pascal BONNAUD, ELANCOURT (FR)

(73) Assignee: TALLANO TECHNOLOGIES, PARIS (FR)

(21) Appl. No.: 19/155,630

(22) PCT Filed: Feb. 15, 2024
(86) PCT No.: PCT/FR2024/050203

§ 371 Date: Aug. 12, 2025

(30) Foreign Application Priority Data
Feb. 21, 2023 (FR) FR2301601

(51) Int. Cl. F16D 65/00; F16D 55/226; F16D 55/228; F16D 121/04

(52) U.S. Cl. CPC F16D 65/0031; F16D 55/226; F16D 55/228; F16D 2121/04

(57) ABSTRACT

A friction braking device includes a caliper, at least one pad movable in translation along an axis (A) of movement relative to the caliper, the pad being intended to engage with a brake disk, and at least one piston movably mounted on the caliper and capable of axially translating the pad, the pad including at least one particle suction region that includes a suction port. The device further includes a suction pipe with a first rigid portion having a first end capable of being opposite the suction port of the pad and a second end, the suction pipe including an axially extendable flexible portion.

### TECHNICAL FIELD

The present disclosure relates to the field of friction braking devices.

### BACKGROUND

The invention concerns a friction braking device intended to equip a road or rail vehicle, for example or a stationary machine including a rotor, such as a wind turbine or an industrial machine.

Such a braking device is known in particular from the document FR 3 057 040 B1 in the name of the Applicant. This device classically includes a so-called floating caliper intended to be mounted on a fixed caliper support and two pads mounted on respective opposite sides of a brake disc rigidly connected to a wheel of a vehicle or a rotor of a stationary machine for example. The device includes in particular a so-called interior pad moved in translation by a piston and intended to come to bear on a first surface of the disc and a so-called exterior pad intended to come to bear on the second surface of the disc opposite the first surface. The piston includes a part subjected to the pressure of a hydraulic fluid, for example oil, in a pressure chamber. Increasing the pressure in said chamber causes axial movement of the piston relative to the caliper and therefore pushes the interior pad against the first surface of the disc. Simultaneously, the rear part of the floating caliper pushes the exterior pad against the second surface of the disc. The disc is therefore braked by a resisting torque generated by the pads rubbing on the corresponding surfaces.

If the pressure in the chamber decreases the piston is retracted and the floating caliper is moved to free the pads. The pads can then be moved away from the disc when the disc is rotating because of a slight runout naturally present in the disc.

Each pad includes a base and a friction lining. The lining is intended to be in contact with the disc, becoming worn by abrasion over time. The abrasion of the linings generates dust particles that can be harmful. In order to limit the emission of such particles it is known to provide means for collecting and aspirating the particles emitted. To this end each pad includes a groove in the lining near a lateral edge of the pad and a suction port opening into said groove and opening axially into the base, opposite the groove. A flexible pipe connects each suction port to a suction and filtration device.

In operation the flexibility of the pipes enables compensation of any axial movement of the pads caused by movement of the piston and/or progressive wear of the pads. However, such pipes have a spring effect tending to apply an unwanted axial force to the pads, this axial force possibly tending to move the pads toward or away from the disc in an uncontrolled manner. This can cause premature wear of the pads or lead to incomplete control of the braking torque.

### SUMMARY

The present disclosure improves this situation.

To this end there is proposed a friction braking device including a caliper, at least one pad mobile in translation along an axis of movement relative to the caliper, said pad being intended to cooperate with a brake disc, and at least one piston movably mounted on the caliper and capable of moving said pad axially in translation, said pad including at least one particle suction zone that includes a suction port, characterized in that the device further includes a suction pipe including a first rigid portion having a first end able to face said suction port of the pad, and a second end, the suction pipe including an axially extendable flexible portion having a first end connected to the first rigid portion and a second end intended to be connected to means for aspirating said particles.

In contrast to the prior art the suction pipe is not flexible over its entire length, which reduces the spring effect of the suction pipe on at least one of the pads. Indeed, thanks to the axially extendable flexible portion the suction pipe can compensate axial movement of said pad, but since the first rigid portion is the one facing the pad, the spring effect exerted on the latter is limited. The residual torques resulting from the contact between at least one of the pads and the brake disc are reduced compared to the prior art.

Note moreover that, thanks to the reduced length of the flexible portion, the suction pipe is more resistant to heat. Indeed, the first rigid portion can have a melting point higher than that of the flexible portion.

Here by “rigid portion” is meant a part of the suction pipe the axial dimension of which is not modified when the piston moves the pad axially. Here by “flexible portion” is meant a part of the suction pipe that is adapted to have its axial dimension modified when the piston moves the pad axially.

The flexible portion being axially extendable, it allows axial movement of the piston.

As described in detail, the first rigid portion can be fixed directly or indirectly to the piston. Said rigid portion can be in one piece with the piston.

In the present text “axial” is to be understood as meaning “substantially parallel to said axis of movement”.

The suction means consist for example of a suction and filtration device.

The second end of the flexible portion can be connected to said suction means directly or indirectly (for example another portion of the pipe can be located between the second end of the flexible portion and the suction means, as in the embodiment described hereinafter).

In accordance with one aspect, said suction pipe can include a second rigid portion having a first end connected to the second end of said flexible portion and a second end intended to be connected to said suction means.

The flexible portion is therefore arranged between said first rigid portion and said second rigid portion. The flexible portion can therefore contract between the first rigid portion and the second rigid portion when the piston is retracted.

In this configuration the suction means are connected directly to the second rigid portion and indirectly (via the second rigid portion) to the second end of the flexible pipe.

The second rigid portion can be fixed to the caliper, for example by a substantially L-shaped arm.

In accordance with one aspect said flexible portion can include at least one bellows.

Thanks to the bellows, which includes pleats, the flexible portion can follow axial movement of the corresponding pad (induced by the piston and the runout of the disc) without being subjected to high traction forces that risk leading to rupture of the flexible portion. Alternatively, the flexible portion could be replaced by a telescopic flexible or rigid portion.

In accordance with one aspect said flexible portion can be made of an elastomer material, for example rubber. The flexible portion can therefore exhibit elastic behavior.

In accordance with one aspect said suction pipe can be fixed to the pad, said first end of the first rigid portion being adapted to come to bear in a sealed manner on said pad opposite said suction port of the pad in such a manner as to connect said suction pipe and said suction zone of the pad.

Bearing in a sealed manner on the pad opposite the suction port, the suction pipe enables aspiration of particles generated by the pad rubbing on a brake disc, thus limiting the quantity of particles ejected to the exterior.

The suction pipe can be fixed to the pad directly or indirectly, that is to say via an additional part.

In accordance with one aspect, said suction pipe can be fixed to the piston, said first end of the first rigid portion being capable of coming to bear in a sealed manner on said pad opposite said suction port of the pad in such a manner as to connect said suction pipe and said suction zone of the pad.

Thus the suction pipe is fixed to the piston and not to the at least one pad, with the result it does not exert an axial force on the corresponding pad. This avoids the aforementioned disadvantages of the prior art.

The suction pipe can be fixed to the piston directly or indirectly, that is to say via an additional part. The first end of the first rigid portion of the suction pipe can come to bear directly or indirectly on said pad in a sealed manner.

The corresponding end of the suction pipe can come in contact against the pad in a sealed manner in the event of braking, that is to say when the piston is bearing on the pad so as to push it axially toward the disc. Particles are produced and consequently must be aspirated in such braking phases. It is therefore also in these phases that a seal must be provided between the pipe and the suction zone of the pad by bearing engagement in a sealed manner.

The seal is still provided between braking phases, which makes it possible to aspirate particles after braking, at least during a so-called cleaning phase immediately following the braking phase.

In some cases the suction pipe can be rigidly connected to a support, said support being fixed onto the piston. Said support can take the form of a metal sheet. Said support can include a central opening through which the piston passes. Said support can be fixed, for example screwed, riveted or welded, to the piston. The suction pipe can be fixed to this support.

Said support can include a port facing a corresponding end of the pipe, said support being adapted to come to bear in a sealed manner on the pad so that the suction port in the pad and the port in the support face one another.

In one aspect the caliper can be a floating caliper capable of being moved axially in translation relative to a caliper support, the device including a first so-called interior pad and a second so-called exterior pad, the first pad being actuated directly by the piston, the second pad being actuated directly by a rear portion of the floating caliper, a first suction pipe being capable of being connected to a suction zone of the first pad, a second suction pipe being capable of being connected to a suction zone of the second pad.

Such a configuration with a floating caliper makes it possible to actuate both the first pad directly and the second pad indirectly via the floating caliper.

Particles emitted by each pad are aspirated via a dedicated pipe.

In accordance with one aspect the rear portion of the floating caliper can include a suction port, the second suction pipe being connected to said suction port of the floating caliper, said suction port of the floating caliper being capable of coming to bear in a sealed manner on the second pad opposite the suction zone of said second pad in such a manner as to connect said second suction pipe and said suction zone of the second pad.

As noted above, the suction port of the caliper can be adapted to contact in a sealed manner the suction port of the second pad when particles are produced.

The second pipe can consist entirely of one or more rigid portions and have no flexible portion. For example the second suction pipe can be produced in a floating casting of the caliper. In particular the second pipe can be in one piece with the floating casting of the caliper.

The seal between the second suction pipe and the second pad is therefore assured thanks to the sealed bearing engagement between the suction port of the caliper and the suction port of the second pad. This therefore limits the number of components in the braking device.

The second suction pipe can have a first end fixed directly or indirectly to the caliper and a second end intended to be connected to a suction and filtration device. Note that thanks to fixing the second suction pipe to the caliper, the second suction pipe is prevented from exerting a force on the second pad. Indeed, instead of fixing the second suction pipe directly onto the second pad, the suction port of the caliper through which particles generated by braking are aspirated is provided by the second suction pipe.

The suction port of the second pad can have a diameter less than the diameter of the suction port of the caliper. This guarantees that a maximum quantity of particles emitted during cooperation between the second pad and the brake disc are aspirated by the second suction pipe. Indeed, if the suction port of the caliper had the same diameter as or a diameter less than that of the suction port of the second pad the risk of particles accumulating at the interface between the two suction ports would be very high.

In some case a first part of the suction port of the caliper includes a substantially annular shoulder shaped to receive said suction pipe.

This improves the seal between caliper and the second suction pipe, given that the second suction pipe is partially inserted in the suction port of the caliper. This limits the risk of particles being expelled to the exterior of the braking device at the interface between the caliper and the second suction port.

Said first end portion corresponds in particular to the end portion of the suction port of the caliper opposite the second pad. Thanks to the shoulder the diameter of the suction port of the caliper is increased in its first end portion. The second suction pipe can therefore be received in the suction port of the caliper while guaranteeing that a passage in the suction pipe in which the particles flow can have a diameter equal to or greater than that of the suction port of the caliper. This limits the risk of particles accumulating at the interface between the suction port of the caliper and the second suction pipe.

The second suction pipe can in particular be a snug fit or a tight fit in said shoulder.

Said second suction pipe can be fixed to the caliper using at least one removable connecting member. The second suction pipe can therefore be replaced easily in the event of wear. For example the second suction pipe can be screwed to the caliper.

The suction port of the second pad can be in a first face of the second pad, the first face of the second pad being made of metal and coming to bear in a sealed manner on a metal first face of the caliper onto which the suction port of the caliper opens. The seal between the second pad and the caliper is therefore assured by a metal-to-metal contact.

In accordance with one aspect the caliper can be a so-called fixed caliper, the device including a first so-called interior pad on the vehicle side and a second so-called exterior pad on the rim side, each pad being actuated directly by at least one piston, a first suction pipe being capable of being connected to a suction zone of the first pad, a second suction pipe being capable of being connected to a suction zone of the second pad.

In such a fixed caliper configuration each pad is actuated by at least one dedicated piston.

As before particles emitted by each pad are aspirated via a dedicated pipe.

In accordance with one aspect said first suction pipe and/or said suction pipe can include a first rigid portion connected to the pad and an axially extendable flexible portion.

Also, the first suction pipe and/or the second suction pipe can have the aforementioned advantages.

The present document also concerns a braking system including a brake disc and a friction braking device of the aforementioned type.

The present document also concerns a vehicle including a braking system of the aforementioned type.

The present document also concerns a stationary machine including a rotor and a braking system of the aforementioned type.

### BRIEF DESCRIPTION OF THE DRAWINGS

Other features, details and advantages will become apparent on reading the following detailed description and analyzing the appended drawings, in which:

FIG. 1 is a schematic perspective view of one embodiment of a friction braking device.

FIG. 2 is a schematic side view of the friction braking device from FIG. 1.

FIG. 3 is another schematic perspective view of the friction braking device from FIG. 1.

FIG. 4 is a schematic front view in section of the friction braking device from FIG. 1.

FIG. 5 is another schematic front view in section of the friction braking device from FIG. 1.

FIG. 6 is a schematic perspective view of a portion of the friction braking device from FIG. 1 including a first pad, a piston and a suction pipe connected to a support surrounding the piston.

FIG. 7 is a schematic perspective view of the suction pipe connected to the support shown in FIG. 6.

FIG. 8 is a schematic partial view in lateral section of the friction braking device from FIG. 1 showing a second pad of said device.

FIG. 9 is a schematic perspective view of another embodiment of a friction braking device.

### DETAILED DESCRIPTION

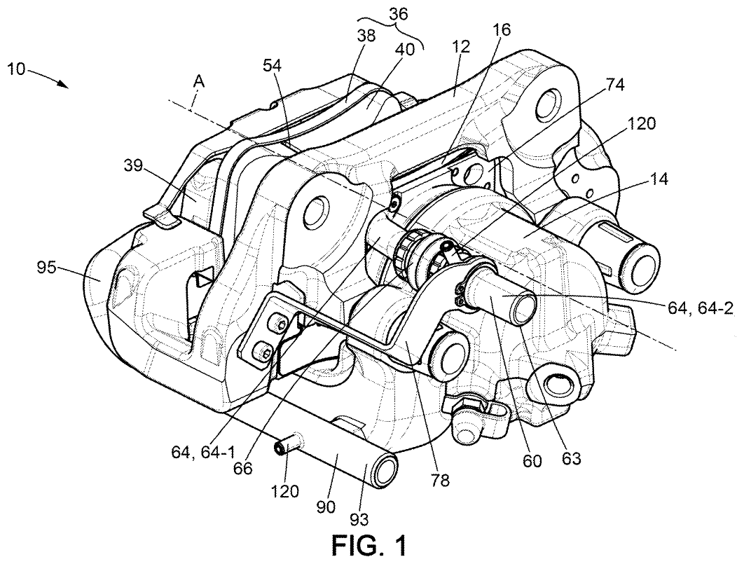

FIG. 1 is a schematic perspective view of one example of a friction braking device 10. The device 10 can be employed in a braking system in a road or rail vehicle for example or in a stationary machine including a rotor, such as a wind turbine or an industrial machine.

The friction device 10 includes a caliper 12. In FIGS. 1 to 8 the caliper 12 is a floating caliper but could equally well be a fixed caliper as will be described in detail. If the caliper 12 is a floating caliper it can be moved in translation relative to a caliper support (not depicted) on which it is mounted.

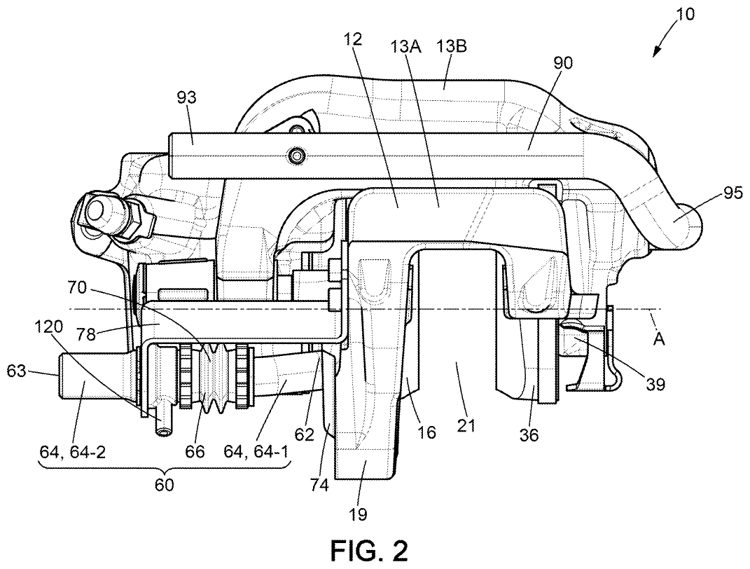

The caliper 12 comprises a fixed part 13A and a floating casting 13B, both seen in FIG. 2.

The device 10 further includes a piston 14 mounted on the caliper 12. The piston 14 can include a portion subjected to the pressure of a hydraulic fluid, for example oil, in a pressure chamber. Increasing the pressure in said chamber causes movement of the piston 14 relative to the caliper in an axial direction A. Hereinafter by “axial” or “axially” is meant substantially parallel to the direction A.

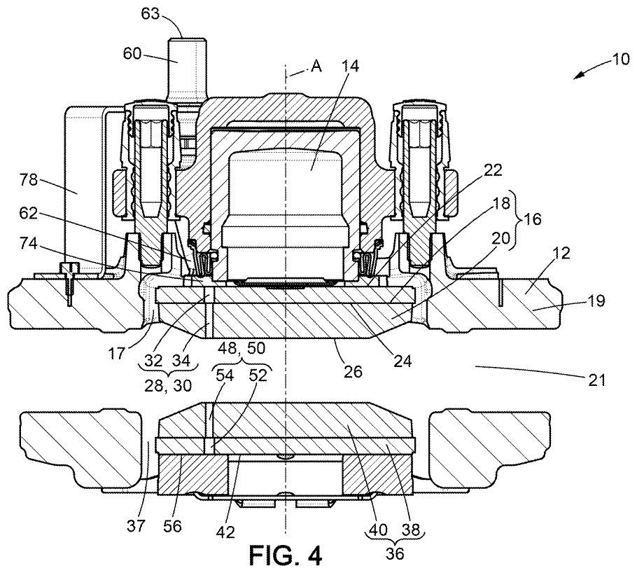

The device 10 includes a first pad 16 also referred to as the front pad. In particular the pad 16 can be arranged in a housing 17 (seen in FIG. 4) in a front part 19 of the caliper 12. The pad 16 is for example mounted directly opposite the piston 14 in the axial direction. In particular, and as can be seen in FIG. 4, the pad 16 can be in contact with the piston 14. As described in detail hereinafter the pad 16 is intended to cooperate with the brake disc (not depicted).

The first pad 16 includes a base 18 and a lining 20.

The base 18 has an external face 22 and an internal face 24 that are opposite one another in the axial direction. The external face 22 comes to bear on the piston 14 and/or the caliper 12.

The thickness of the base 18 is for example between 3 mm and 5 mm. Here by the “thickness of the base” is meant the dimension of the base 18 in the axial direction A.

The base 18 is preferably made of metal.

The lining 20 is fixed to the internal face 24 of the base 18. The lining 20 is formed by a friction material commonly known as a ferodo material.

The lining 20 includes a friction face 26 axially opposite the face of the lining 20 that is fixed to the base 18. The friction face 26 is intended, during braking phases, to come axially to bear on a first face of the brake disc, which turns about an axis substantially parallel to the axial direction A. In particular, the friction face 26 comes to bear on the first face of the brake disc when the piston 14 is moved in the direction A toward the brake disc.

The lining 20 and the disc release particles resulting from abrasion when the friction face 26 comes to bear on the brake disc during braking. This causes wear of the lining 20 and the disc. The thickness (that is to say the axial dimension) of the lining therefore decreases progressively during the service life of the pad 16.

As depicted in FIG. 4 the pad 16 includes a particle suction zone 28. The particle suction zone 28 includes a suction port 30 formed by a first cavity 32 in the base 18 and a groove 34 in the lining 20. The suction port extends substantially axially for example.

The first cavity 32 passes through the base 18 between its external face 22 and its internal face 24 opposite at least a portion of the groove 34 in the lining 20. The groove 34 extends axially between the friction face 26 and the second face of the lining 20. In other words the depth of the groove 34 is equal to the thickness of the lining 20. Also, particles released by abrasion can be collected in the groove 34 and then aspirated via the cavity 32 in the base 18.

The device includes a first suction pipe 60 to aspirate particles collected in the groove 34. The first suction pipe 60 has a first end 62 and an opposite second end 63.

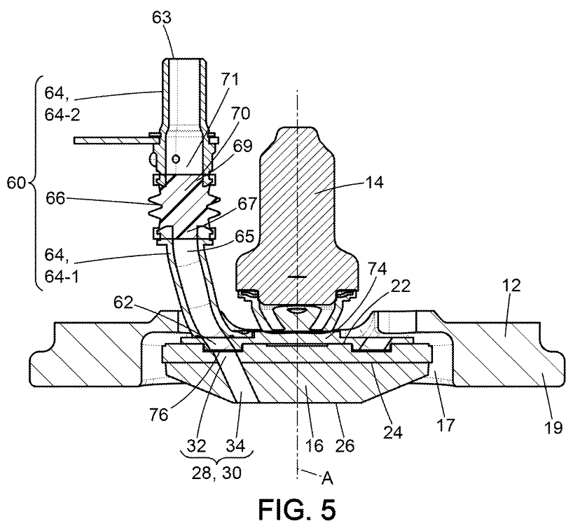

The first end 62, seen in FIG. 5 in particular, is able to come to bear in a sealed manner either directly or indirectly on the first pad 16. The end 62 is advantageously adapted to come to bear in a sealed manner opposite the suction port 30 in the pad 16. Thus the suction pipe 60 is connected to the suction zone 28 of the plate 16. This limits the risk of ejection to the outside of particles formed by abrasion of the pad 16 and the disc when they are in contact with one another.

The end 62 of the suction pipe 60 advantageously comes to bear in a sealed manner on the pad 16 in a braking phase. Indeed, as explained above during braking phases the pad 16 comes to bear axially on the brake disc and particles are therefore formed by abrasion.

The seal between the suction pipe 60 and the pad 16 is also maintained between braking phases, at least during a cleaning phase immediately following a braking phase. This enables aspiration of the particles after braking.

The second end 63 of the pipe 60 is for its part intended to be connected to suction means (not depicted). The suction means consist for example of a suction and filtration device. Such a device is configured to aspirate particles formed by abrasion of the pad 16 and the brake disc when they come into contact with one another.

In some cases the pipe 60 can include at least one rigid portion 64 and at least one flexible portion 66. Here by “rigid portion” is meant a portion of the pipe 60 the axial dimension of which is not modified when the piston 14 moves the pad 16 axially. Here by “flexible portion” is meant a portion of the pipe 60 that is adapted to have its axial dimension modified when the piston 14 moves the pad 16 axially.

In the non-limiting example shown in the figures the pipe 60 includes a first rigid portion 64-1, a second rigid portion 64-2 and a flexible portion 66 between the two rigid portions 64-1, 64-2.

The first rigid portion 64-1 has a first end that corresponds to the first end 62 of the pipe 60 described above. Also, the first end 62 of the first rigid portion 64-1 is adapted to come to bear in a sealed manner and either directly or indirectly on the pad 16, in particular opposite the suction port 30 of the pad 16.

As will be described in detail the first rigid portion 64-1 can be fixed to the piston 14 or directly to the pad 16.

The first rigid portion 64-1 further has a second end 65 that is axially opposite its first end 62. As is clear from FIG. 5 the second end 65 is connected to the flexible portion 66.

The flexible portion 66 has a first end 67 and an axially opposite second end 69.

The first end 67 is connected to the first rigid portion 64-1. In particular the first end 67 of the flexible portion 66 is connected to the second end 65 of the first rigid portion 64-1.

The second end 69 is intended to be connected to the means for aspirating particles generated by abrasion. In the example represented here the connection between the second end 69 and the particle suction means is an indirect connection via the second rigid portion 64-2. Nevertheless, in an example that is not depicted the second end 69 of the flexible portion 66 could be connected directly to the suction means.

The flexible portion 66 is axially extendable. The flexible portion 66 can advantageously be made of an elastomer material, for example rubber. The flexible portion 66 can therefore exhibit elastic behavior enabling it to track axial movement of the piston 14.

In the figures the flexible portion 66 includes at least one bellows 70 including pleats.

The second rigid portion 64-2 has a first end 71. As clearly depicted in FIG. 5 the first end 71 is connected to the second end 69 of the flexible portion 66. The flexible portion 66 is therefore arranged between the first rigid portion 64-1 and said second rigid portion 64-2. The flexible portion 66 is therefore able to contract between the first rigid portion 64-1 and the second rigid portion 64-2 when the piston 14 is retracted.

The second rigid portion 64-2 also has a second end that corresponds to the second end 63 of the pipe 60 described above. Also, the second end 63 of the second rigid portion 64-2 is intended to be connected to the suction means. For example, the second end 63 can be connected directly to the suction means.

Thanks to the presence of the rigid portions 64-1, 64-2 the pipe 60 is not flexible over its entire length, which reduces the spring effect of the pipe 60 on the pad 16. In particular, given that the first rigid portion 64-1 is that which bears directly or indirectly in a sealed manner on the pad 16 and the one that is fixed directly or indirectly to the piston 14, the spring effect exerted on the pad 16 is limited. The residual torques in the braking device are therefore reduced compared to the prior art.

Note moreover that thanks to the reduced length of the flexible portion 66, the pipe 60 can be more heat resistant. In fact the rigid portions 64-1, 64-2 can have a melting point higher than that of the flexible portion 66.

In the non-limiting embodiment depicted in the figures the suction pipe 60 is fixed to the piston 14. In particular the first rigid portion 64-1 of the pipe 60 is fixed to the piston 14. To be more precise, the first rigid portion 64-1 can be fixed to the piston by its first end 62.

The pipe 60 is therefore fixed to the piston 14 and not to the pad 16 with the result that the pipe 60 exerts no axial force on the pad 16. This therefore prevents the pad 16 being moved toward or away from the disc in an uncontrolled manner, which reduces the risk of premature wear of the pad 16 and enables more complete control of the braking torque.

When the pipe 60 is fixed to the piston its end 62 is advantageously able to come to bear in a sealed manner on the pad 16 opposite the suction port 30. The first suction pipe 60 and the suction port 30 of the pad 16 are therefore connected.

The pipe 60 and in particular its first rigid portion 64-1 can be fixed directly to the piston 74. For example, the first rigid portion 64-1 can be in one piece with the piston 14.

Alternatively, the first rigid portion 64-1 of the pipe 60 can be fixed indirectly to the piston 14. For example, as depicted in the figures the first rigid portion 64-1 can be connected indirectly to the piston by an additional part 74. The additional part 74 is for example a support that is fixed, for example screwed, riveted or welded, to the piston 14.

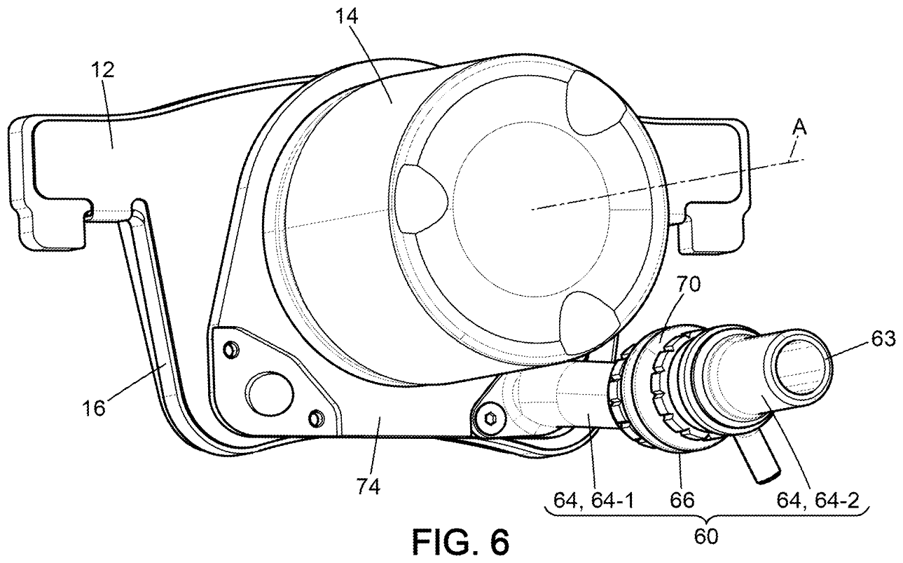

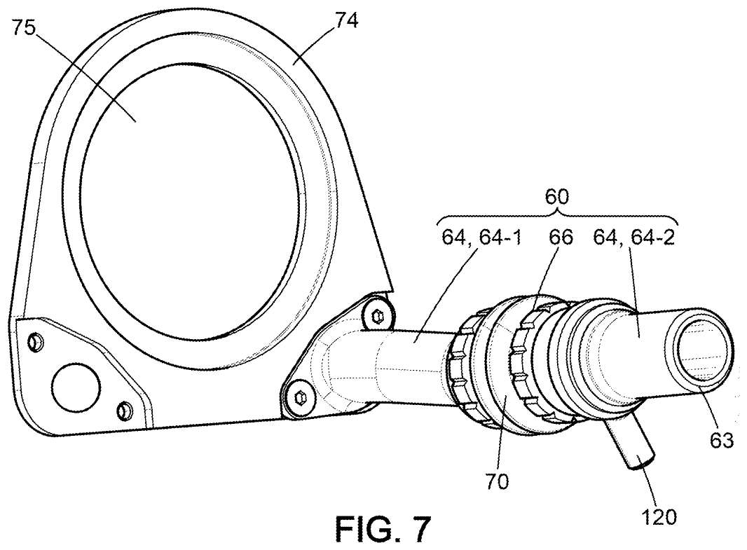

The support 74 can take the form of a metal sheet. As emerges from FIG. 7 the support 74 includes a central opening 75. The piston 14 passes through this opening 75, as can be seen in FIG. 6 in particular.

The end 62 of the pipe 60 is rigidly connected to the support 74. The support 74 can include a port 76 facing the end 62 of the pipe 60. The support 74 is therefore able to come to bear in a sealed manner on the pad 16 so that the suction port 30 of the pad 16 and the port 76 of the support face one another.

In an alternative embodiment that is not depicted the pipe 60 could be fixed directly to the pad 16. As before the end 62 of the pipe 60 is then able to come to bear in a sealed manner on the first pad 12 opposite the suction port 30. The first suction pipe 60 and the suction zone 30 of the pad 16 are therefore connected.

As can be seen in the figures the caliper can further include an L-shaped arm 78 that enables the pipe 60 to be fixed to the caliper 12. The arm 78 preferably fixes one of the rigid portions 64, in this instance the second rigid portion 64-2, to the caliper 12.

A second pad 36, also known as the rear pad, is provided in the device 10. The second pad 36 can be arranged in a housing 37 in the rear portion 39 of the caliper 12. As emerges from the figures, in particular from FIG. 4, the second pad 36 faces the first pad 16 in the axial direction. A space 21 intended to receive the brake disc is formed between the two pads 16,36.

The second pad 36 includes a base 38 and a lining 40. The base 38 and the lining 40 are respectively similar or identical to the base 18 and the lining 20 described above. Also, for conciseness they are not described in detail hereinafter. Note only that the second pad 36 includes a suction zone 48 including a suction port 50 that is formed by a first cavity 52 and a groove 54 respectively similar or identical to the first cavity 32 and the groove 34 of the first pad 16. The suction port 50 extends substantially axially for example.

Note also that the second pad 36, in particular the friction face of its lining 40, is intended to come to bear axially on a second face of a brake disc axially opposite the first face of the disc during braking phases. As in the case of the front pad 16 this causes abrasion of the lining 40 and the disc, therefore generating particles.

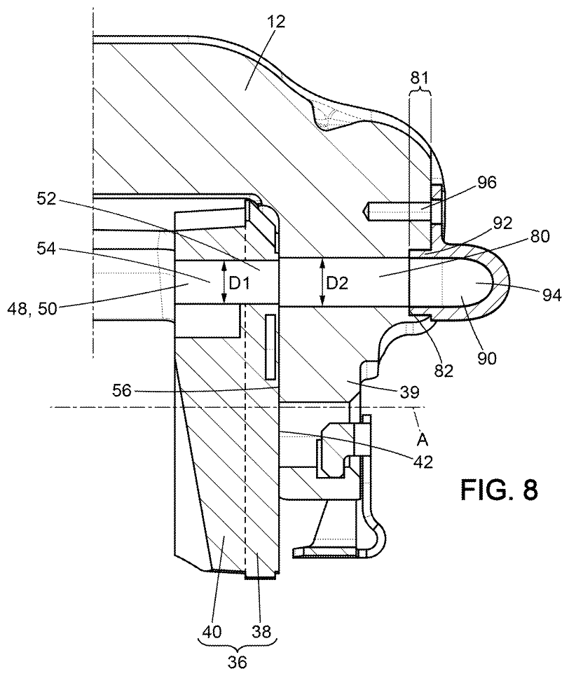

As emerges from FIGS. 4 and 8 the second pad 36 has a first face 42 that comes to bear axially on a first face 56 of the caliper 12. The first face 42 of the second pad 36 is similar or identical to the external face 22 of the base 18 of the first pad 16. The first face 42 of the pad 32 and the first face 56 of the caliper 12 are advantageously made of metal.

If the caliper 12 is a floating caliper the second pad 36 is advantageously mounted on a guide and slides (not depicted). The movement of the second pad 36 toward the brake disc is therefore induced by axial movement of the caliper 12, in particular of its rear portion 39, relative to the caliper support. Such axial movement of the rear portion 39 of the caliper 12 causes the second pad 36 to slide on the guide and slides on which it is mounted. The second pad 36 is therefore actuated directly by the rear portion 39 of the floating caliper 12. Also, in this floating caliper configuration only one piston, here the piston 14, enables both direct actuation of the first pad 16 and indirect actuation of the second pad 36 via the floating caliper.

The suction port 50 of the second pad 36 can be in the first face 42 of the pad 36.

The rear portion 39 of the caliper 12 can include a suction port 80 seen in FIG. 8. The suction port 80 passes through the rear portion 39 of the caliper 12, between the first face 56 and the outside of the caliper 12. For example, the suction port 80 extends substantially axially.

When the face 42 of the pad 36 and the face 56 of the caliper 12 are in contact the suction port 50 of the pad 36 and the suction port of the caliper 12 are advantageously aligned. In particular the suction port 80 of the caliper 12 is adapted to come to bear in a sealed manner on the second pad 36 opposite the suction port 50. The first face 42 of the pad 32 and the first face 56 of the caliper 12 being made of metal, the seal between the second pad 32 and the caliper 12 is provided by a metal-on-metal contact. Thanks to this seal between the pad 32 and the caliper 12 particles generated by abrasion of the pad 32 and the disc during braking phases can be aspirated by suction means, limiting the quantity of particles released into the environment, as will be described in detail.

The suction port 80 of the caliper 12 can be adapted to come to bear in a sealed manner on the suction port 50 of the second pad 36 in the event of braking, during which particles are produced by abrasion. Between braking phases the pad 36 is pushed toward the rear portion 39 which also enables the seal to be maintained between the second pad 32 and the caliper 12. This enables remaining particles to be aspirated during cleaning phases.

As FIG. 8 shows, the diameter D1 of the suction port 50 of the second pad 36 can be less than the diameter D2 of the suction port 80 of the caliper 12. This guarantees that a maximum quantity of particles emitted during cooperation between the second pad 36 and the brake disc is aspirated by the suction means. In fact if the suction port 80 of the caliper 12 had the same diameter as or a diameter less than that of the suction port 50 of the second pad 36 the risk of particles accumulating at the interface between the two suction ports 50, 80 would be very high.

In order to connect the suction ports 50, 80 to the suction means the device 10 includes a second suction pipe 90. The second pipe 90 may be produced in continuity with the floating casting 13B.

The second pipe 90 has a first end 92 and a second end 93.

The first end 92 of the pipe 90 is fixed directly or indirectly to the caliper 12. In the figures the first end 92 is connected directly to the suction port 80 of the caliper 12. This enables indirect connection of the pipe 90 to the suction zone 48 of the second pad 36. Particles generated by abrasion of the pad 36 and the disc can therefore be moved from the suction zone 48 of the pad 36 to the pipe 90 via the port 80 in the caliper.

In particular the first end 92 is at least in part a snug or tight fit in the port 80. The seal between the caliper 12 and the suction pipe 90 is therefore improved, which limits the risk of particles being expelled to the exterior of the device 10 at the interface between the caliper 12 and the second suction pipe 90.

In the non-limiting example seen in the figures the suction port 80 includes a shoulder 82 in an end portion 81 opposite the second pad 36. Thanks to the shoulder 82 the diameter D2 of the suction port 80 of the caliper 12 increases relative to the rest of the port 80 in its end portion 81.

The shoulder 82 is substantially annular for example. The shoulder 82 is advantageously shaped to receive the second suction pipe 90, in particular the first end 92 thereof. The end 92 of the pipe 90 can in particular be a snug or tight fit in the end portion 81 of the port 80.

As the diameter of the suction port 80 of the caliper 12 increases from its first end portion 81 thanks to the shoulder 82, the second suction pipe 90 can be received in the suction port 80 of the caliper, guaranteeing that a passage 94 of the suction pipe in which particles flow has a diameter equal to or greater than that of the suction port 80 of the caliper. This limits the risk of accumulation of particles at the interface between the suction port 80 of the caliper 12 and the second suction pipe 90.

Fixing the suction pipe 90 to the caliper 12 prevents the second suction pipe 90 from exerting forces on the second pad 36.

The second end 93 of the pipe 90 is intended to be connected to the suction means. As indicated above such means can be a suction and filtration device. Note that the first pipe 60 and the second pipe 90 can be connected to the same suction and filtration device or to separate suction and filtration devices.

The second suction pipe 90 preferably consists entirely of one or more rigid portions. In other words the pipe 90 preferably has no flexible portion similar to the flexible portion 66 of the pipe 60.

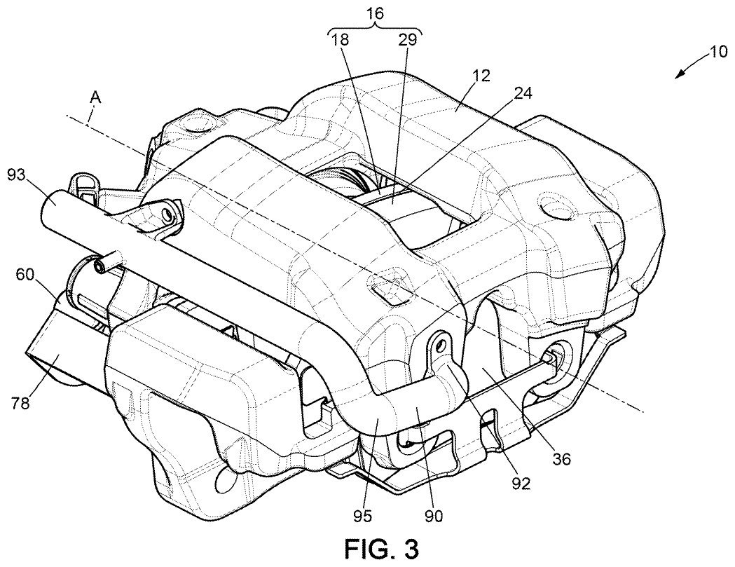

As emerges clearly from FIG. 3 the shape of the pipe 90 can include an elbow 95. This elbow 95 enables the end 93 of the pipe 90 to be placed on the same side of the caliper 12 as the end 63 of the pipe 60. It is therefore simpler to connect the two pipes 60, 90 to the same suction and filtration device.

As can also be seen in FIG. 8 the second suction pipe 90 can moreover be fixed to the caliper 12 by means of at least one removable connecting member 96. The pipe 90 can therefore be replaced easily in the event of wear. The removable connecting member 96 is for example a screw.

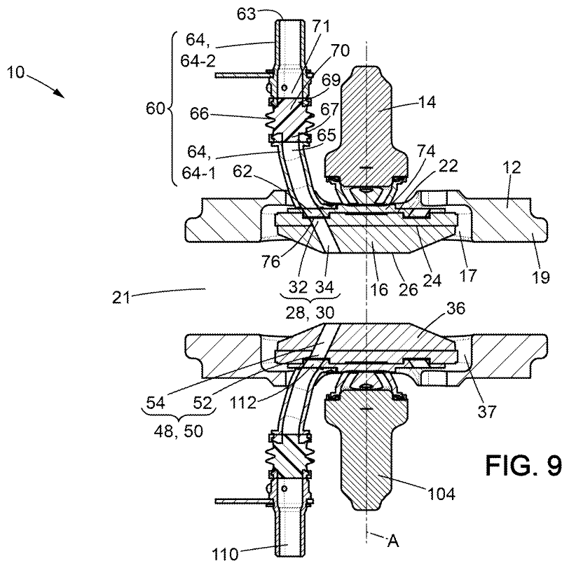

The variant of the device 10 depicted in FIG. 9 is described next. In that figure elements of the device 10 that are identical or similar to those of the example from FIGS. 1 to 8 are designated by the same reference. Also, for conciseness, they are not described below, the description given hereinabove for such elements being valid for this variant.

Here the caliper 12 is a fixed caliper. The fixed caliper is distinguished from the floating caliper described hereinabove in that the second pad 36 is moved axially by a piston 104 similar or identical to the piston 14 that moves the first pad 16. Also, the second pad 36 is not moved axially by the movement of the caliper 12 relative to the caliper support.

Furthermore, in order to track movement of the piston 104 the fixed caliper in FIG. 9 can include a pipe 110 similar or identical to the pipe 60 described hereinabove. That is to say the pipe 110 can include at least one rigid portion and at least one flexible portion similar or identical to the rigid portions 64-1, 64-2 and the flexible portion 66 of the pipe 60.

Finally, the pipe 110 is mounted in a similar or identical manner to the pipe 60 and this is consequently not described hereinafter. It is specified only that, in a manner analogous to the pipe 60, the pipe 110 can be connected directly or indirectly to the piston 104 or to the pad 36. One end 112 of the pipe 110 is adapted to come to bear in a sealed manner on the pad 36 opposite the suction port 50.

Note that in the case of the fixed caliper as in that of the floating caliper after the pads 16, 36 rub on the brake disc the pads 16, 36 are moved away from the disc because of a slight runout (not depicted) in the disc. In particular the pads 16, 36 are moved away from the disc when it rotates.

In the case of the floating caliper depicted in the figures the pads 16, 36 are moved away from the brake disc when the piston 14 is retracted (and therefore moved away from the interior pad 16) and the caliper 12 is moved relative to the caliper support in such a manner as to be moved away from the interior pad 36. The pads 16, 36 are released, which enables them to be moved in a direction away from the brake disc by the action of the slight runout of the disc.

In the case of the fixed caliper, the piston 14, 104 associated with the interior pad 16 and the exterior pad 36 is retracted in such a manner as to be moved away from the corresponding pad. The pads 16, 36 can therefore be moved in a direction away from the brake disc by the action of the slight runout of the disc.

The present disclosure is not limited to the embodiments described hereinabove by way of example only, but rather encompasses all variants that the person skilled in the art might envisage within the scope of protection applied for. For example, as depicted in the figures, each of the pipes 60, 90, 110 can include a tapping 120. Such tappings 120 are preferably not provided in the device 10 that is intended to be installed in a vehicle or a stationary machine including a rotor. These tappings 120 are useful only if the device 10 is employed to carry out experimental tests in order to measure the reduced pressure in the pipe that carries them.

1-10. (canceled)

11. A friction braking device including
a caliper,
at least one pad that is mobile in translation along an axis of movement relative to the caliper, said at least one pad being intended to cooperate with a brake disc, and
at least one piston movably mounted on the caliper and capable of moving said pad axially in translation, said at least one pad including at least one particle suction zone that includes a suction port,
a suction pipe including:
a first rigid portion having a first end able to face said suction port of the pad and
a second end,
the suction pipe including an axially extendable flexible portion having a first end connected to the first rigid portion and a second end intended to be connected to means for aspirating said particles.

12. The friction braking device as claimed in claim 1, wherein said suction pipe includes a second rigid portion having a first end connected to the second end of said flexible portion and a second end intended to be connected to said suction means.

13. The friction braking device as claimed in claim 1, wherein said flexible portion includes at least one bellows.

14. The friction braking device as claimed in claim 1, wherein said flexible portion is made of an elastomer material.

15. The friction braking device as claimed in claim 1, wherein said suction pipe is fixed to the at least one pad, said first end of the first rigid portion being adapted to contact in a sealed manner said at least one pad opposite said suction port of the at least one pad in such a manner as to connect said suction pipe and said suction zone of the at least one pad.

16. The friction braking device as claimed in claim 1, wherein said suction pipe is fixed to the piston, said first end of the first rigid portion being capable of contacting in a sealed manner said pad opposite said suction port of the at least one pad in such a manner as to connect said suction pipe and said suction zone of the at least one pad.

17. The friction braking device as claimed in claim 1, wherein the caliper is a floating caliper capable of being moved axially in translation relative to a caliper support, the at least one pad including a first pad and a second pad, the first pad being actuated directly by the piston, the second pad being actuated directly by a rear portion of the floating caliper, the suction pipe being a first suction pipe being capable of being connected to a suction zone of the first pad, the friction braking device further comprising a second suction pipe being capable of being connected to a suction zone of the second pad.

18. The friction braking device as claimed in claim 17, wherein the rear portion of the floating caliper includes a suction port, the second suction pipe being connected to said suction port of the floating caliper, said suction port of the floating caliper being capable of contacting in a sealed manner the second pad opposite the suction zone of said second pad in such a manner as to connect said second suction pipe and said suction zone of the second pad.

19. The friction braking device as claimed in claim 1, wherein the caliper is a so-called fixed caliper, the at least one pad including a first pad on a vehicle side and a second pad on a rim side, the first and second pads being actuated directly by at least one piston, the suction pipe being a first suction pipe being capable of being connected to a suction zone of the first pad, the friction braking device further comprising a second suction pipe being capable of being connected to a suction zone of the second pad.

20. The friction braking device as claimed in claim 7, wherein said first suction pipe and/or the second suction pipe include(s) a first rigid portion connected to the pad and an axially extendable flexible portion.
